(19) United States
(12) Patent Application Publication
(10) Pub. No.: US 2005/0143512 A1
(43) Pub. Date: Jun. 30, 2005

(54) Attenuation material

(76) Inventor: John Graham Bryant, Swansea (GB)

Correspondence Address: VINSON & ELKINS L.L.P., 1001 FANNIN STREET, 2300 FIRST CITY TOWER, HOUSTON, TX, 77002-6760, US

(21) Appl. No.: 10/240,298

(22) PCT Filed: Mar. 29, 2001
(86) PCT No.: PCT/GB01/01441

(30) Foreign Application Priority Data
Mar. 29, 2000 (GB) 0007525.9

(51) Int. Cl. C08L 1/00

(52) U.S. Cl. 524/432; 524/435; 524/493

(57) ABSTRACT

An attenuation material and a method of making such an attenuation material. The attenuation material includes a matrix of elastomer having mixed therewith particulate vulcanised rubber and particulate magnetisable material, the mixture being substantially free of sublimable foaming agents.

The present invention is concerned with an attenuation material and a method of manufacture of such a material.

It is a general desire to improve the environment through noise reduction. Noise pollution is an environmental problem in many industries. For example noise is a problem in military vehicles, consumer vehicles, factories, and also in communal buildings.

It is therefore an aim of the present invention to alleviate some of the problems identified above.

It is a further aim of the present invention to provide an attenuation material which can be used, for example, for acoustic insulation and noise reduction, or for reduction of interference of radio frequency (RF) waves.

It is a further aim of the present invention to provide a method of making an attenuation material which can be used, for example, for noise reduction and acoustic insulation, or for reduction of interference of radio frequency (RF) waves.

It is a further aim of the present invention to provide a laminated panel suitable for use as an attenuation panel.

It is yet a further aim of the present invention to provide an attenuation material which is fire resistant.

Therefore, according to a first aspect of the present invention, there is provided an attenuation material which includes a matrix of elastomer having mixed therewith particulate vulcanised rubber and particulate magnetisable material, the mixture being substantially free of sublimable foaming agents.

Advantageously, the mixture further includes a filler material, such as particulate carbon black, clay or limestone or finely divided paper. However, particulate silica is preferred. It is preferred that the filler material, such as silica, is in finely divided form, preferably having a particle size in the range of about 50 to 500 microns. A preferred particle size is about 120 microns.

When silica is used, it may advantageously be waste silica, such as, for example, waste silica from skimmings from power station lakes.

The magnetisable material and filler are preferably in a ratio of about 4 to 1 by weight.

The, magnetisable material may be a ferrous material, which may, in some embodiments, be coated with copper; this embodiment is particularly preferred when the material is to be used in a Faraday screen. The magnetisable material for use according to the invention may be mill scale (which is preferred), any ferrous oxide material (such as Fe₃O₄) or copper silicate.

Typically, the particulate magnetisable material is in finely divided form, preferably having a particle size in the range of about 25 to 400 micron. Further preferably, the particulate magnetisable material has a particle size of about 300 micron.

The particulate vulcanised rubber is preferably present in the form of discrete particles. The vulcanised rubber should therefore be such that it is substantially free of reaction with the elastomer when the latter is cured.

It is preferred that the particulate vulcanised rubber is obtained cryogenically, by comminution of waste rubber compounds (for example, from waste tyres or the like). Such waste rubber compounds generally include natural rubber and/or SBR. The vulcanised rubber may advantageously include comminuted rubber tyres such as waste or worn tyres. Disposal of waste or worn tyres would previously be in landfill sites. Therefore, according to a further aspect of the present invention there is provided a use for waste tyres.

The vulcanised rubber is preferably in finely divided form. It is further preferred that the vulcanised rubber has a particle size of less than about 500 microns, further preferably less than about 120 microns.

Typically, the attenuation material further includes at least one fire retardant material.

Preferably, the attenuation material further includes an adhesion enhancing material such as neoalkoxy zirconate, which is present so as to promote adhesion of the attenuation material to a number of materials (for example, steel, high performance polymers such as polyamides, PET and aluminium). It is further preferred that the neoalkoxy zirconate is added in the ratio of about 1 to 10 parts per 100 of the elastomer, by weight. A preferred ratio is 5 parts per 100 of the elastomer, by weight.

It is preferred that the matrix of elastomer includes at least one of the following batch ingredients:
KELTAN (a Product of DSM-NV Ethylene Propylene Rubber)
SPHERON 5000A Medium Fine Carbon Black
Zinc Oxide Active
Stearic Acid
PEG 4000 (polyethylene glycol soap)
Britomya BSH 20 (plasticiser)
Flexon 815 Liquid (plasticiser)
KEZADOL GR (processing aid)
RHENOGRAN 580 Sulphur (vulcanising agent)
RHENOGRAN TMTD 80 Tetramethylthiuram Disulphide (vulcanising agent)
RHENOGRAN MBT 80 Mercaptobenzothiazole (vulcanising agent)
RHENOGRAN MBTS 80 Benzothiazyl Disulphide (vulcanising agent)

Preferred solid mixes for use according to the invention are set out in the following Table 1.

TABLE 1

| | Matrix A | Matrix B | Matrix C | Matrix D |
|---|---|---|---|---|
| Keltan 314 | 2.4000 | 2.4000 | 2.4000 | 2.700 |
| Keltan 4903 | 9.6000 | 9.6000 | 9.6000 | 10.6000 |
| Zinc Oxide Active | 0.3500 | 0.3500 | 0.3500 | 0.3900 |
| Stearic Acid 1800 | 0.1200 | 0.1200 | 0.1200 | 0.1300 |
| PEG 4000 | 0.1200 | 0.1200 | 0.1200 | 0.1300 |
| TE 80 Powder | 0.2000 | — | — | — |
| STUKTOL W816 | 0.2000 | — | — | — |
| Baco Superfine 7 | 14.8000 | — | — | — |
| Spheron 5000A | 2.0000 | 16.8000 | 16.8000 | 18.7000 |
| Britomya BSH 20 | 4.8000 | | 4.8000 | 5.3000 |
| Flexon 815 Liquid | 8.8000 | 8.8000 | 8.800 | 9.800 |
| KEZADOL GR | 0.5000 | 0.5000 | 0.500 | 0.5600 |
| Rhenogran CTP80 (PVI) | 0.0900 | 0.0900 | 0.090 | 0.1000 |
| RHENOGRAN 580 | 0.1100 | 0.1100 | 0.1100 | 0.1200 |
| RHENOGRAN | 0.8800 | 0.0800 | 0.0800 | 0.0900 |
| TMTD 80 | | | | |
| RHENOGRAN MBT 80 | 0.0270 | 0.0270 | 0.0270 | 0.0300 |
| RHENOGRAN | 0.0900 | 0.0900 | 0.0900 | 0.1000 |
| MBTS 80 | | | | |
| XETAL Filler A | 13.0000 | 13.0000 | 13.000 | 9.7000 |
| Vulcanised Rubber | | | | |
| XETAL Filler B Mill | 21.6000 | 30.3000 | 13.00 | 9.7000 |
| scale, copper | | | | |
| silicate or Fe₃O₄ | | | | |
| Total Weight (kg) | 78.8871 | 87.1871 | 69.8871 | 68.1500 |

The elastomer is preferably of a type different to that normally employed in tyres, the latter (as mentioned above generally including natural rubber and/or SBR). It is particularly preferred that the elastomer should be a polyolefin type rubber, such as an ethylene-propylene rubber or EPDM.

In a preferred embodiment, the matrix of elastomer, the vulcanised rubber, mill scale or silica or Fe₃O₄ are preferably present in the following ratios:

| | | Mill Scale/ |
|---|---|---|
| Matrix of | Vulcanised | Copper Silicate/ |
| Elastomer | Rubber | Fe₃O₄ |
| 100 | 20 | 20 |
| 100 | 25 | 25 |
| 100 | 30 | 30 |
| 100 | 35 | 35 |
| 100 | 40 | 40 |
| 100 | 45 | 45 |
| 100 | 50 | 50 |

According to a second aspect of the present invention there is provided a method of manufacturing a material suitable for use as an attenuation material, which method includes:
a) providing a mixture comprising a matrix of elastomer having mixed therewith particulate vulcanised rubber and particulate magnetisable material, the mixture being substantially free of sublimable foaming agents; and
b) forming the mixture into at least one sheet.

The solid ingredients (including at least the magnetisable material and vulcanised rubber, and filler material, when present), may be mixed together prior to further mixing with the elastomer, prior to curing or vulcanisation of the latter.

The latter further mixing is typically carried out in a mixer such as a Banbury rotor type mixer. The rotor speed of the mixer is typically in the range of 60 to 100 rpm, preferably about 80 rpm.

The particulate vulcanised rubber may be added to the elastomer before addition of the other solid ingredients, or with the other solid ingredients. Typically the mixing of the solid ingredients with the elastomer is for about 4 to 12 minutes, preferably for about 8 minutes; such mixing is typically at a temperature of about 80° C. to 110° C.

The magnetisable material and the filler may be mixed prior to addition to the elastomer material in step b).

The sheet formed in step b) is typically permitted to cure.

The sheet obtained in step b) may be formed by passing the mixture produced in step a) through a dump mill, then onto a sheeting mill and finally onto a three bowl calender for sheeting off. Advantageously, the thickness of the sheets may be varied. A preferred thickness of the sheets is from about 0.2 mm up to about 6 mm, when in an unexpanded form.

The method typically includes a further step c) after step b) whereby the mixture is cured.

The attenuation level of the material may depend on the thickness of the resulting sheet. The sheets may be used for a wide variety of uses. Typical uses include in buildings (traditionally built buildings with cavity space and roof trusses can be lined with the material according to the present invention), refitting of buildings (for example, existing buildings that have changed uses to pubs, clubs, discos etc), building door linings, blinds, in road, rail or air transport (for example as a lining material inside cabins, carriages, tunnels and barriers on roads) and in general household and industrial machinery.

Advantageously, the method may further include the step of curing the elastomer matrix after step b). The material may be cured in a number of ways, for example, in line ovens or microwave ovens, however an autovac oven is preferred. It is preferred that curing is at a temperature in the range of 155° C. to 165° C. A lower temperature range will permit curing of the elastomer matrix; however, this will incur a longer cycle time.

Advantageously, the sheet formed in step (b) may be laminated to paperboard, plasterboard, woven fabrics or the like.

According to a further embodiment of the present invention, it is preferred that at least one fire retardant is added to the material prior to step b).

According to yet a further embodiment of the present invention, it is preferred that the material is magnetised to provide hysteresis characteristics. The material is typically magnetised after step b). Advantageously a magnetic screen created around the material provides attenuation of electromagnetic induction and radio frequency (RF) waves. The screen is silk screen printed inductive ink with apertures to screen RF frequencies.

According to yet a further embodiment of the present invention, an adhesion enhancing agent such as neoalkoxy zirconate may be added to the mixture prior to or during step (b) so as to promote adhesion of the material to a number of materials (for example, steel, high performance polymers such as polyamides, PET and aluminium). It is preferred that the adhesion enhancing agent is added in the ratio of about 1 to 10 (preferably 5) parts per 100, by weight of the material made.

According to a further aspect of the present invention, there is provided laminate which includes attenuation material according to the first aspect of the present invention, having bonded thereto a second material such as, for example, steel, high performance polymers such as polyamides, PET and aluminium.

1. An attenuation material comprising a mixture, the mixture comprising a matrix of elastomer having mixed therewith a particulate vulcanised rubber and a particulate magnetisable material, the mixture being substantially free of sublimable foaming agents.

2. The attenuation material according to claim 1, wherein the mixture further comprises a filler material.

3. The attenuation material according to claim 2, wherein the filler material comprises at least one of particulate carbon black, particulate clay, particulate limestone, particulate silica and finely divided paper.

4. The attenuation material according to claim 2 or 3, wherein the filler material comprises a finely divided form having a particulate size in the range of from about 50 to about 500 microns.

5. The attenuation material according to claim 3, wherein the particulate silica comprises waste silica.

6. The attenuation material according to claim 1, wherein the magnetisable material comprises a ferrous material.

7. The attenuation material according to claim 1, wherein the magnetisable material comprises at least one of millscale, copper silicate and Fe₃O₄.

8. The attenuation material according to claim 1, wherein the magnetisable material comprises a finely divided form.

9. The attenuation material according to claim 8, wherein the magnetisable material has a particle size of about 300 microns.

10. The attenuation material according to claim 1, wherein the magnetisable material and a filler are present in a ratio of about 4 to 1 by weight.

11. The attenuation material according to claim 1, wherein the vulcanised rubber comprises discrete particles.

12. The attenuation material according to claim 1, wherein the vulcanised rubber is substantially free of reaction with the elastomer when the elastomer is cured.

13. The attenuation material according to claim 1, wherein the particulate vulcanised rubber is obtained cryogenically, by comminution of waste rubber compounds.

14. The attenuation material according to claim 13, wherein the waste rubber compounds comprise at least one of natural rubber and SBR.

15. The attenuation material according to claim 1, wherein the vulcanised rubber comprises comminuted rubber tires, the comminuted rubber tires comprising at least one of waste and worn tires.

16. The attenuation material according to claim 1, wherein the vulcanised rubber is in a finely divided form.

17. The attenuation material according to claim 16, wherein the vulcanised rubber has a particle size of less than about 500 microns.

18. The attenuation material according to claim 1, further comprising at least one fire retardant material.

19. The attenuation material according to claim 1, further comprising an adhesion enhancing material.

20. The attenuation material according to claim 19, wherein the adhesion enhancing material is added in the ratio of about 50 parts per 100 of the matrix of elastomer, by weight.

21. The attenuation material according to claim 1, wherein the matrix of elastomer includes at least one of the following batch ingredients:
(A) KELTAN;
(B) SPHERON 5000A Medium Fine Carbon Black;
(C) Zinc Oxide Active;
(D) Stearic Acid;
(E) PEG 4000;
(F) Britomya BSH 20;
(G) Flexon 815 Liquid;
(H) KEZADOL GR;
(I) RHENOGRAN 580 Sulphur;
(J) RHENOGRAN TMTD 80 Tetramethylthiuram Disulphide;
(K) RHENOGRAN MBT 80 Mercaptobenzothiazole; and
(L)RHENOGRAN MBTS 80 Benzothiazyl Disulphide.

22. The attenuation material according to claim 1, wherein the elastomer is substantially free of at least one of a natural rubber and an SBR.

23. The attenuation material according to claim 1, wherein the elastomer comprises at least one of polyolefin type rubber and EPDM.

24. The attenuation material according to claim 1, wherein the matrix of elastomer, the vulcanised rubber and the magnetisable material are present in a ratio in a range of from about 100:20:20 to about 100:50:50.

25. An attenuation material comprising a composition comprising at least one of matrix A, matrix B, matrix C and matrix D, wherein matrix A, matrix B, matrix C and matrix D comprise:

| | Matrix A | Matrix B | Matrix C | Matrix D |
|---|---|---|---|---|
| Keltan 314 | 2.4000 | 2.4000 | 2.4000 | 2.700 |
| Keltan 4903 | 9.6000 | 9.6000 | 9.6000 | 10.6000 |
| Zinc Oxide Active | 0.3500 | 0.3500 | 0.3500 | 0.3900 |
| Stearic Acid 1800 | 0.1200 | 0.1200 | 0.1200 | 0.1300 |
| PEG 4000 | 0.1200 | 0.1200 | 0.1200 | 0.1300 |
| TE 80 Powder | 0.2000 | — | — | — |
| STUKTOL W816 | 0.2000 | — | — | — |
| Baco Superfine 7 | 14.8000 | — | — | — |
| Spheron 5000A | 2.0000 | 16.8000 | 16.8000 | 18.7000 |
| Britomya BSH 20 | 4.8000 | | 4.8000 | 5.3000 |
| Flexon 815 Liquid | 8.8000 | 8.8000 | 8.800 | 9.800 |
| KEZADOL GR | 0.5000 | 0.5000 | 0.500 | 0.5600 |
| Rhenogran CTP80(PVI) | 0.0900 | 0.0900 | 0.090 | 0.1000 |
| RHENOGRAN 580 | 0.1100 | 0.1100 | 0.1100 | 0.1200 |
| RHENOGRAN | 0.8800 | 0.0800 | 0.0800 | 0.0900 |
| TMTD 80 | | | | |
| RHENOGRAN MBT 80 | 0.0270 | 0.0270 | 0.0270 | 0.0300 |
| RHENOGRAN | 0.0900 | 0.0900 | 0.0900 | 0.1000 |
| MBTS 80 | | | | |
| XETAL Filler A | 13.0000 | 13.0000 | 13.000 | 9.7000 |
| Vulcanised Rubber | | | | |
| XETAL Filler B Mill | 21.6000 | 30.3000 | 13.00 | 9.7000 |
| scale, copper silicate | | | | |
| or Fe₃O₄ | | | | |
| Total Weight (kg) | 78.8871 | 87.1871 | 69.8871 | 68.1500 |

26. A method of manufacturing a material suitable for use as an attenuation material, the method comprising:
1) providing a mixture comprising a matrix of elastomer having mixed therewith particulate vulcanised rubber and particulate magnetisable material, the mixture being substantially free of sublimable foaming agents; and
2) forming the mixture into at least one sheet.

27. The method according to claim 26, wherein at least the magnetisable material and the vulcanised rubber are mixed together prior to further mixing with the elastomer, prior to curing or vulcanisation of the elastomer.

28. The method according to claims 26 or 27, wherein the further mixing is typically carried out in a mixer, the mixer comprising a Banbury rotor type mixer.

29. The method according to claim 28, wherein the mixer has a rotor speed in the range of from about 60 to about 100 rpm.

30. The method according to claim 26, wherein the vulcanised rubber is not added to the elastomer after the addition of the magnetisable material.

31. The method according to claim 26, wherein the mixture in step 1) is mixed for about 4 to about 12 minutes.

32. The method according to claim 26, wherein the mixing is at a temperature from about 80° C. to about 110° C.

33. The method according to claim 26, wherein the magnetisable material and a filler are mixed prior to addition of the elastomer.

34. The method according to claim 26, wherein the sheet in step 2) is formed by passing the mixture produced in step 1) through a dump mill, then onto a sheeting mill and finally onto a three bowl calender for sheeting off.

35. The method according to claim 26, further comprising the step of curing the mixture formed in step 1) after the mixture has been formed into the sheet.

36. The method according to claim 35, wherein the curing takes place in at least one of a line oven, a microwave oven, or an autovac oven.

37. The method according to claim 35, wherein the curing is at a temperature in the range from about 155° C. to about 165° C.

38. The method according to claim 26, wherein the sheet has a thickness of from about 0.2 mm to about 6 mm, when in an unexpanded form.

39. The method according to claim 26, wherein the sheet formed in step 2) may be laminated to at least one of paperboard, plasterboard, and woven fabrics.

40. The method according to claim 26, wherein the material is magnetised.

41. A fire retardant body comprising the attenuation material according to claims 1 or 25, and a fire retardant.

42. A laminate material comprising the attenuation material according to claims 1 or 25, having bonded thereto a second material, the second material comprising at least one of steel, high performance polymers, PET and aluminium, wherein the high performance polymers comprise polyamides.

43. The attenuation material according to claim 2 or 3, wherein the filler material comprises a finely divided form having a particulate size of about 120 microns.

44. The attenuation material according to claim 4, wherein the particulate silica comprises waste silica.

45. The attenuation material according to claim 6, wherein the magnetisable material is coated with copper.

46. The attenuation material according to claim 8, wherein the magnetisable material has a particle size in the range of from about 25 to 400 microns.

47. The attenuation material according to claim 16, wherein the vulcanised rubber has a particle size of less than about 120 microns.

48. The attenuation material according to claim 23, wherein the polyolefin type rubber comprises an ethylene propylene rubber.

49. The method according to claim 28, wherein the mixer has a rotor speed of about 80 rpm.

50. The method according to claim 26, wherein the mixture in step 1) is mixed for about 8 minutes.

51. The method according to claim 26, wherein step 1) further comprises the matrix of elastomer having mixed therewith a filler.

52. The method according to claim 26, wherein at least the magnetisable material, the vulcanised rubber, and a filler are mixed together prior to further mixing with the elastomer, prior to curing or vulcanisation of the elastomer.

53. The method according to claim 26, wherein the vulcanised rubber is not added to the elastomer after the addition of the magnetisable material and a filler.

54. The attenuation material according to claim 5, wherein the waste silica is from power station lakes.

55. The attenuation material according to claim 19, wherein the adhesion enhancing material comprises neoalkoxy zirconate.

56. The attenuation material according to claim 24, wherein the magnetisable material comprises at least one of millscale, copper silicate and Fe₃O₄.

57. The method according to claim 30, wherein the vulcanised rubber is added to the elastomer before addition of the magnetisable material.

58. The method according to claim 30, wherein the vulcanised rubber is added to the elastomer at substantially the same time as the magnetisable material.

59. The method according to claim 44, wherein the waste silica is from power station lakes.

60. The method according to claim 53, wherein the vulcanised rubber is added to the elastomer before addition of the magnetisable material and the filler.

61. The method according to claim 53, wherein the vulcanised rubber is added to the elastomer at substantially the same time as the magnetisable material and the filler.
